(19) United States
(12) Patent Application Publication
(10) Pub. No.: US 2024/0414641 A1
(43) Pub. Date: Dec. 12, 2024

(54) SYSTEM AND METHOD FOR WIRELESS ACCESS POINT ASSIGNMENT

(71) Applicant: Wistron Corporation, New Taipei City (TW)

(72) Inventors: Yu Chi Chu, New Taipei City (TW); Ching-Nan Lin, New Taipei City (TW)

(73) Assignee: Wistron Corporation, New Taipei City (TW)

(21) Appl. No.: 18/348,354

(22) Filed: Jul. 7, 2023

(30) Foreign Application Priority Data
Jun. 6, 2023 (TW) 112121128

(51) Int. Cl. H04W 48/20; H04B 17/318

(52) U.S. Cl. CPC H04W 48/20; H04B 17/318

(57) ABSTRACT

A system and a method for wireless access point (AP) assignment are provided. The method includes: scanning a plurality of wireless devices by a first wireless AP to obtain a first subset of the plurality of wireless devices; scanning the plurality of wireless devices by a second wireless AP to obtain a second subset of the plurality of wireless devices; calculating a first probability of assigning a first wireless device to the first wireless AP and a second probability of assigning the first wireless device to the second wireless AP in response to the first wireless device of the plurality of wireless devices being included in both the first subset and the second subset; assigning the first wireless device to the first wireless AP to generate an assignment result in response to the first probability being greater than the second probability; and outputting the assignment result.

### CROSS-REFERENCE TO RELATED APPLICATION

This application claims the priority benefit of Taiwan application serial no. 112121128, filed on Jun. 6, 2023. The entirety of the above-mentioned patent application is hereby incorporated by reference herein and made a part of this specification.

### BACKGROUND OF THE INVENTION

### Field of the Invention

The invention relates to a wireless communication technique, and in particular to a system and a method for wireless access point (AP) assignment.

### Description of Related Art

The server of the Internet of things (IoT) system often needs to control a large number of wireless devices (for example: digital lights in temples or electronic tags in supermarkets). In order to communicate with various wireless devices, the IoT system may include wireless access points (or coordinators, gateways) respectively disposed in different locations. A wireless access point may act as a relay between the server and a plurality of wireless devices. However, the wireless access point has limited connection quota. When the number of wireless devices served by the wireless access point reaches the connection quota, the wireless access point is unable to serve more wireless devices. Therefore, before running the IoT system, the user needs to first assign a wireless access point to all wireless devices.

However, when there are too many wireless access points or wireless devices, the assignment of wireless access points becomes very complicated. In addition, if a wireless device is to leave the IoT system or a new wireless device is to be added to the IoT system, the user needs to re-assign wireless access points for all wireless devices. Accordingly, the setup of an IoT system takes a lot of time. Furthermore, wireless devices activated later may be assigned to unsatisfactory wireless access points, resulting in poor communication quality of the wireless devices.

### SUMMARY OF THE INVENTION

The invention provides a system and a method for wireless access point assignment that may automatically assign wireless devices to serving wireless access points.

A system for wireless access point assignment of the invention includes a plurality of wireless devices; a first wireless access point, a second wireless access point, and a server. The server is communicatively connected to the first wireless access point and the second wireless access point and configured to perform: scanning a plurality of wireless devices by the first wireless access point to obtain a first subset of the plurality of wireless devices; scanning the plurality of wireless devices by the second wireless access point to obtain a second subset of the plurality of wireless devices; calculating a first probability of assigning a first wireless device to the first wireless access point and a second probability of assigning the first wireless device to the second wireless access point in response to the first wireless device of the plurality of wireless devices being included in both the first subset and the second subset; assigning the first wireless device to the first wireless access point to generate an assignment result in response to the first probability being greater than the second probability; and outputting the assignment result.

In an embodiment of the invention, the server is further configured to perform: measuring a first signal strength of the first wireless device via the first wireless access point; measuring a second signal strength of the first wireless device via the second wireless access point; comparing the first signal strength and the second signal strength in response to the first probability being equal to the second probability; and assigning the first wireless device to the first wireless access point to generate the assignment result in response to the first signal strength being greater than the second signal strength.

In an embodiment of the invention, the first signal strength is associated with a received signal strength indicator.

In an embodiment of the invention, the server is further configured to perform: obtaining a number of wireless devices in the first subset; and calculating the first probability by dividing a remaining quota of the first wireless access point by the number of wireless devices.

In an embodiment of the invention, the server is further configured to perform: decreasing the remaining quota of the first wireless access point in response to assigning the first wireless device to the first wireless access point.

In an embodiment of the invention, the server is further configured to perform: determining whether the remaining quota of the first wireless access point is zero; determining whether an unassigned second wireless device of the plurality of wireless devices is included in the second subset in response to determining that the remaining quota is zero; and outputting an alert message in response to the second wireless device not being included in the second subset.

In an embodiment of the invention, the server is further configured to perform: adding the first probability and the second probability to generate a first total probability corresponding to the first wireless device; comparing the first total probability corresponding to the first wireless device and a second total probability corresponding to a second wireless device of the plurality of wireless devices; and assigning the first wireless device to the first wireless access point prior to assigning the second wireless device to the first wireless access point or the second wireless access point in response to the first total probability being less than the second total probability.

In an embodiment of the invention, the server is further configured to perform: assigning the first wireless device to the first wireless access point to generate the assignment result in response to the first wireless device being in the first subset but not in the second subset.

In an embodiment of the invention, the server is further configured to perform: determining whether a remaining quota of the first wireless access point is zero in response to the first wireless device being in the first subset but not in the second subset; and assigning the first wireless device to the first wireless access point in response to determining that the remaining quota is not zero.

In an embodiment of the invention, the above server is further configured to perform: outputting an alert message in response to determining that the remaining quota is zero.

A method for wireless access point assignment of the invention includes: scanning a plurality of wireless devices by a first wireless access point to obtain a first subset of the plurality of wireless devices; scanning the plurality of wireless devices by a second wireless access point to obtain a second subset of the plurality of wireless devices; calculating a first probability of assigning a first wireless device to the first wireless access point and a second probability of assigning the first wireless device to the second wireless access point in response to the first wireless device of the plurality of wireless devices being included in both the first subset and the second subset; assigning the first wireless device to the first wireless access point to generate an assignment result in response to the first probability being greater than the second probability; and outputting the assignment result.

Based on the above, the invention may dynamically perform wireless access point assignment for wireless devices according to signal strength based on an optimal pairing mechanism. System administrators do not need to manually assign wireless devices to wireless access points. Therefore, the invention may significantly reduce time and labor needed to build the system.

### BRIEF DESCRIPTION OF THE DRAWINGS

FIG. 1 shows a schematic diagram of a system for wireless access point assignment shown according to an embodiment of the invention.

FIG. 2 shows a flowchart of a method for wireless access point assignment shown according to an embodiment of the invention.

FIG. 3 shows a flowchart of another method for wireless access point assignment shown according to an embodiment of the invention.

### DESCRIPTION OF THE EMBODIMENTS

In order to make the content of the invention more comprehensible, the following specific embodiments are taken as examples in which the invention may actually be implemented. In addition, wherever possible, elements/members/steps using the same reference numerals in the drawings and embodiments represent the same or similar components.

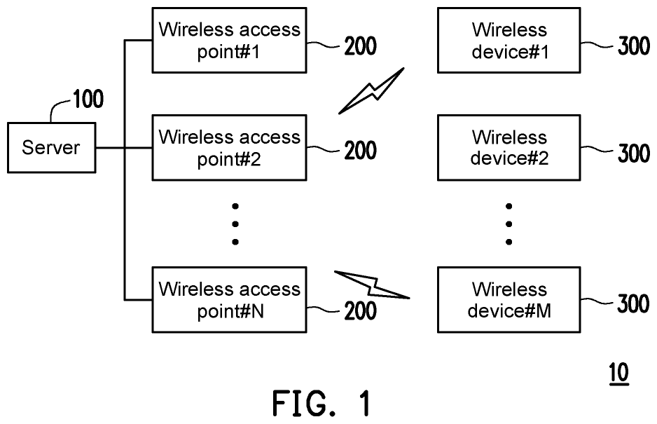

FIG. 1 shows a schematic diagram of a system 10 for wireless access point assignment according to an embodiment of the invention. The system 10 may include a server 100, one or a plurality of wireless access points 200, and one or a plurality of wireless devices 300. In the present embodiment, the system 10 may include an N number of wireless access points such as a wireless access point #1,a wireless access point #2 . . . a wireless access point #N, and may include an M number of wireless access points such as a wireless device #1, a wireless device #2 . . . a wireless device #M, wherein N or M is any positive integer.

The server 100 is communicatively connected to each of the wireless access points 200, and may assign the serving wireless access points 200 to each of the wireless devices 300. The server 100 may communicate with the wireless devices 300 via the wireless access points 200 serving the wireless devices 300.

The server 100 has necessary components for running the management server 110 such as a processing unit (such as a processor but not limited thereto), a communication unit (such as various communication chips, mobile communication chips, Bluetooth chips, WiFi chips, etc., but not limited thereto) and storage units (for example: removable RAM, flash memory, hard disk, etc., but not limited thereto).

The wireless access points 200 have a processing unit, a communication unit, and a storage unit, and may be used to transmit or receive a wireless signal. The wireless devices 300 are, for example, IoT devices, a tablet computers, smart phones, or wireless sensors. The wireless devices 300 may be controlled by a wireless signal from the wireless access points 200.

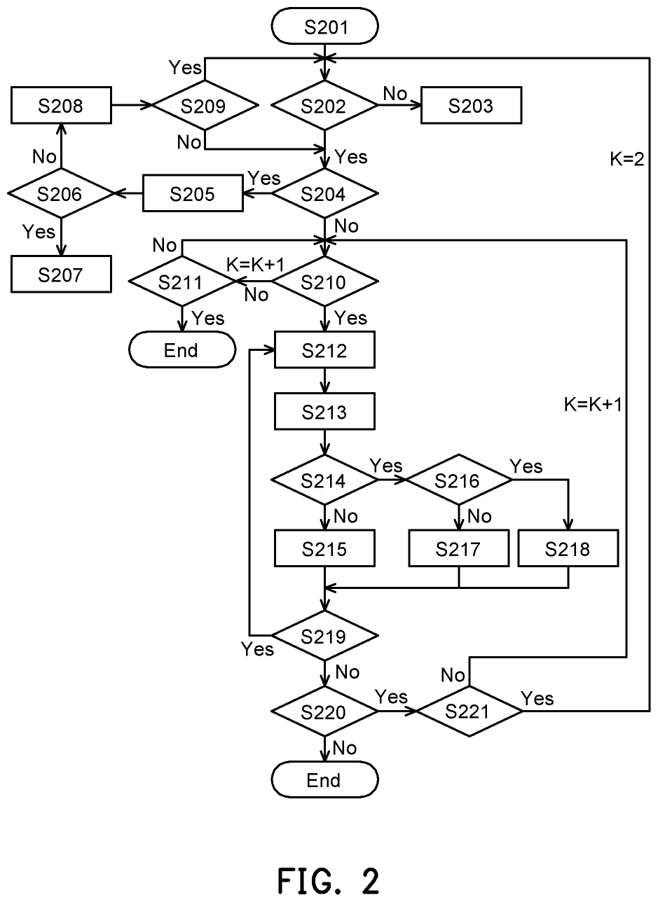

FIG. 2 shows a flowchart of a method for wireless access point assignment according to an embodiment of the invention, wherein the method may be implemented by the system 10 shown in FIG. 1.

In step S201, the server 100 may scan a plurality of wireless devices 300 via each of the wireless access points 200 to obtain a subset of the plurality of wireless devices 300 corresponding to the wireless access points 200. The subset includes one or a plurality of wireless devices 300 capable of communicating with the wireless access points 200. During the scanning process, the server 100 may measure the signal strength of the wireless signals from the wireless devices 300 in the subset via the wireless access points 200. The signal strength may include, but not limited to, a received signal strength indicator (RSSI).

In an embodiment, it is assumed that the system 10 includes three wireless access points 200 including a wireless access point #A to a wireless access point #C, and includes nine wireless devices 300 including a wireless device #1 to a wireless device #9.

The server 100 may scan each of the wireless devices 300 via each of the wireless access points 200 to obtain the scanning results shown in Table 1. The value in each field in Table 1 represents the signal strength (unit: dBm) of the wireless devices 300 measured by the corresponding wireless access points 200. For example, the value in the field corresponding to the wireless access point #A and the wireless device #2 is “−6”, which means that the signal strength of the wireless signal from the wireless device #2 measured by the wireless access point #A is “−6 dBm”.

TABLE 1

| | #1 | #2 | #3 | #4 | #5 | #6 | #7 | #8 | #9 |
|---|---|---|---|---|---|---|---|---|---|
| #A | | −6 | | | −3 | −3 | −5 | | −12 |
| #B | −12 | −6 | −3 | −9 | −6 | | | | −3 |
| #C | | | | −8 | −6 | −9 | | −12 | −6 |

If the field in Table 1 has no value, it means that the wireless access point 200 corresponding to the field does not scan the wireless device 300 corresponding to the field. For example, the wireless access point #A does not scan the wireless device #1. Therefore, the wireless device #1 does not belong to the subset corresponding to the wireless access point #A. It may be seen from Table 1 that the subset of the wireless access point #A includes the wireless devices #2, #5, #6, #7, and #9, the subset of the wireless access point #B includes the wireless devices #1, #2, #3, #4, #5, #6, and #9, and the subset of the wireless access point #C includes the wireless devices #4, #5, #6, #8, and #9.

In step S202, the server 100 may determine whether each of the unassigned wireless devices 300 is included in at least a subset (i.e., at least one wireless access point 200 scanned to the wireless device 300). If each of all the wireless devices 300 is included in at least one subset, step S204 is performed. If any wireless device 300 is not included in any subset, step S203 is performed.

In an embodiment, the server 100 may store a wireless access point list recording the wireless access points 200 that may serve the wireless devices 300. The server 100 may determine whether the wireless devices 300 are included in the subset of the wireless access points 200 in the wireless access point list, so as to determine whether the wireless devices 300 are included in at least one subset. The initial wireless access point list may include all wireless access points 200 of the system 10.

In step S203, the server 100 may output an alert message, wherein the alert message may indicate that the system 10 includes a wireless device 300 not scanned by any wireless access point 200. Accordingly, the user may redesign the location of each of the wireless access points 200 or each of the wireless devices 300.

In step S204, the server 100 may determine whether the one or plurality of unassigned wireless devices 300 include a wireless device 300 only belonging to a single subset. If there is a wireless device 300 only belonging to a single subset, step S205 is performed. If there is not a wireless device 300 only belonging to a single subset, step S210 is performed.

Taking Table 1 as an example, it is assumed that the wireless devices #1 to #9 in Table 1 are not assigned to any wireless access point. The server 100 may determine that the wireless device #1 only belongs to a single subset corresponding to the wireless access point #B, the wireless device #3 only belongs to a single subset corresponding to the wireless access point #B, the wireless device #7 only belongs to a single subset corresponding to the wireless access point #A, and the wireless device #8 only belongs to a single subset corresponding to the wireless access point #C.

In step S205, the server 100 may select one of the one or plurality of wireless devices 300 only belonging to a single subset. The server 100 may select the wireless device 300 randomly, or select the wireless device 300 according to user-defined rules. For example, if there is a plurality of wireless devices 300 only belonging to a single subset, the server 100 may select the wireless device 300 with the smallest index from the plurality of wireless devices 300. Taking Table 1 as an example, the wireless device 300 only belonging to a single subset includes the wireless devices #1, #3, #7, and #8. The server 100 may select the wireless device #1 with the smallest index from the wireless devices #1, #3, #7, and #8.

In step S206, the server 100 may determine whether the remaining quota of the wireless access point 200 corresponding to the selected wireless device 300 is zero. The remaining quota represents the number of wireless devices 300 that the wireless access point 200 may still serve. The remaining quota may be defined by the server 100 according to the hardware specification of the wireless access point 200, or may be defined by the user. If the remaining quota of the wireless access point 200 is zero, the server 100 may determine that the remaining quota of the wireless access point 200 is insufficient, and enter step S207. If the remaining quota of the wireless access point 200 is not zero, step S208 is performed.

Taking the wireless device #1 and the corresponding wireless access point #B in Table 1 as an example, if the server 100 determines that the remaining quota of the wireless access point #B is zero, the server 100 may determine that the remaining quota of the wireless access point #B is insufficient, and perform step S207. If the server 100 determines that the remaining quota of the wireless access point #B is not zero, the server 100 may perform step S208.

In step S207, the server 100 may output an alert message, wherein the alert message may indicate that the selected wireless device 300 may be not assigned to any wireless access point 200. Accordingly, the user may redesign the location of each of the wireless access points 200 or each of the wireless devices 300.

In step S208, the server 100 may assign the selected wireless device 300 to the corresponding wireless access point 200, wherein the selected wireless device 300 belongs to the subset of the wireless access point 200. The server 100 may record the assignment result. Taking the wireless device #1 in Table 1 as an example, the server 100 may assign the wireless device #1 to the wireless access point #B, and record the assignment result, as shown in Table 2, wherein the field containing “#1” and “(#B)” represents that the wireless device #1 is assigned to the wireless access point #B.

TABLE 2

| | #1 | | | | | | | | |
|---|---|---|---|---|---|---|---|---|---|
| | (#B) | #2 | #3 | #4 | #5 | #6 | #7 | #8 | #9 |
| #A | | −6 | | | −3 | −3 | −5 | | −12 |
| (3) | | | | | | | | | |
| #B | −12 | −6 | −3 | −9 | −6 | | | | −3 |
| (2) | | | | | | | | | |
| #C | | | | −8 | −6 | −9 | | −12 | −6 |
| (3) | | | | | | | | | |

Moreover, the server 100 may decrease the remaining quota of the wireless access points 200 assigned with the wireless devices 300 by one. For example, it is assumed that the wireless access points #A, #B, and #C may serve three wireless devices 300 respectively. Therefore, the remaining quotas of wireless access points #A, #B, and #C may be three respectively. After the server 100 assigns the wireless device #1 to the wireless access point #B, the server 100 may reduce the remaining quota of the wireless access point #B from three to two, as shown in Table 2, wherein the field containing “#B” and “(2)” means that the remaining quota of the wireless access point #B is two.

In step S209, the server 100 may determine whether the remaining quota of the wireless access point 200 assigned with the wireless device 300 in step S208 is zero. If the remaining quota is zero, the wireless access point 200 has no ability to serve other wireless devices 300. Accordingly, the server 100 may delete the wireless access point 200 from the wireless access point list, and perform step S202 again. If the remaining quota is not zero, the server 100 may perform step S204 again.

Taking Table 1 as an example, after steps S202 to S209 are repeatedly performed for many times, the server 100 may complete the assignment of wireless access points for the wireless devices #1, #3, #7, and #8, and generate the assignment results shown in Table 3. The wireless devices #1 and #3 are assigned to the wireless access point #B, and the remaining quota of the wireless access point #B is one. The wireless device #7 is assigned to the wireless access point #A, and the remaining quota of the wireless access point #A is two. The wireless device #8 is assigned to the wireless access point #C, and the remaining quota of the wireless access point #C is two.

TABLE 3

| | #1 | | #3 | | | | #7 | #8 | |
|---|---|---|---|---|---|---|---|---|---|
| | (#B) | #2 | (#B) | #4 | #5 | #6 | (#A) | (#C) | #9 |
| #A | | −6 | | | −3 | −3 | −5 | | −12 |
| (2) | | | | | | | | | |
| #B | −12 | −6 | −3 | −9 | −6 | | | | −3 |
| (1) | | | | | | | | | |
| #C | | | | −8 | −6 | −9 | | −12 | −6 |
| (2) | | | | | | | | | |

In step S210, the server 100 may determine whether each of the unassigned wireless devices 300 is included in a K number of subsets (i.e.: a K number of wireless access points 200 are scanned to the wireless device 300), wherein K is a positive integer greater than or equal to two, and the initial value of K is two. If there is a wireless device 300 included in the K number of subsets, step S212 is performed. If there is no wireless device 300 included in the K number of subsets, the server 100 adds one to K (that is, makes K=K+1), and step S211 is performed.

Taking Table 3 as an example, assuming that K is equal to two, the server 100 may determine that the wireless devices 300 belonging to the K number of subsets include the wireless device #2, the wireless device #4, and the wireless device #6.

In step S211, the server 100 may determine whether the value K is greater than the value M (i.e.: the number of all wireless access points 200 included in the system 10). If the value K is greater than the value M, the server 100 outputs the assignment result and ends the process. If the value K is less than or equal to the value M, step S210 is performed again.

In step S212, the server 100 may calculate the probability that the unassigned wireless devices 300 included in the K number of subsets are assigned to each of the wireless access points 200. Specifically, the server 100 may obtain the number of unassigned wireless devices 300 in the subset of the wireless access points 200. The server 100 may divide the remaining quota of the wireless access points 200 by the number of wireless devices to calculate the probability that the wireless devices 300 are assigned to the wireless access points 200. Since the wireless devices 300 are included in the K number of subsets (i.e., the wireless devices 300 may be assigned to one of the K number of wireless access points 200), the server 100 may calculate a K number of probabilities for the wireless devices 300. The server 100 may further add up the K number of probabilities to calculate the total probability of the wireless devices 300.

Taking Table 3 as an example, the subset of the wireless access point #A includes the wireless devices #2, #5, #6, and #9, four unassigned wireless devices 300, and therefore the server 100 may determine that the number of wireless devices of the wireless access point #A is equal to four. It is assumed that P (#X-#Y) represents the probability that the wireless device #X is assigned to the wireless access point #Y, and P (#X) represents the total probability corresponding to the wireless device #X. The server 100 may calculate the probability P (#2-#A) that the wireless device #2 is assigned to the wireless access point #A=(remaining quota of the wireless access point #A)/(number of wireless devices of the wireless access point #A)=2/4. The server 100 may further calculate total probability P (#2) corresponding to the wireless device #2=P (#2-#A)+P (#2-#B)=3/4. The server 100 may calculate the corresponding probability for each of the wireless devices 300 included in the K number of subsets based on a similar manner, as shown in Table 4.

TABLE 4

| | #2 | #4 | #6 |
|---|---|---|---|
| #A | P(#2-#A) = 2/4 | — | P(#6-#A) = 2/4 |
| #B | P(#2-#B) = 1/4 | P(#4-#B) = 1/4 | — |
| #C | — | P(#4-#C) = 2/4 | P(#6-#C) = 2/4 |
| Total probability | P(#2) = 3/4 | P(#4) = 3/4 | P(#6) = 1 |

In step S213, the server 100 may select a selected wireless device 300 from one or a plurality of wireless devices 300 included in the K number of subsets. Specifically, for one or a plurality of wireless devices 300 included in the K number of subsets, the server 100 may compare the total probabilities of the wireless devices 300 with each other. The server 100 may select the wireless device 300 with the smallest total probability from the one or a plurality of wireless devices 300 as the selected wireless device 300. A smaller total probability of the wireless device 300 means a higher probability that the wireless device 300 may not be served by any wireless access point 200. In order to reduce the probability that the wireless device 300 may not be served by any wireless access point 200, the server 100 may preferentially perform wireless access point assignment for the wireless device 300 with a smaller total probability. In an embodiment, if there are a plurality of wireless devices 300 with the same total probability, the server 100 may randomly select the selected wireless device 300 from the plurality of wireless devices 300, or select the selected wireless device 300 according to user-defined rules (for example: according to the size of the index).

Taking Table 4 as an example, since the total probability P (#2) of the wireless device #2 is equal to the total probability P (#4) of the wireless device #4 and less than the total probability P (#6) of the wireless device #6, the server 100 may select the wireless devices #2 and #4 with a smaller total probability from the wireless devices #2, #4, and #6 (the server 100 performs wireless access point assignment for the wireless device #6 after completing wireless access point assignment for the wireless devices #2 and #4). Next, the server 100 may randomly select the wireless device #2 from the wireless devices #2 and #4 as the selected wireless device.

In step S214, the server 100 may determine whether the K number of probabilities of the selected wireless device 300 are the same. If the K number of probabilities of the selected wireless device 300 are the same, step S216 is performed. If the K number of probabilities of the selected wireless device 300 include different probabilities, step S215 is performed. Taking Table 4 as an example, assuming that the selected wireless device 300 is the wireless device #2, the server 100 may determine that the two probabilities of the wireless device #2 are different (P (#2-#A)/P (#2-#B)), and performs step S215. Assuming that the selected wireless device 300 is the wireless device #6, the server 100 may determine that the two probabilities of the wireless device #6 are the same (P (#6-#A)=P (#6-#C)), and performs step S216.

In step S215, the server 100 may compare the K number of probabilities of the selected wireless device 300, assign the selected wireless device 300 to the wireless access point 200 corresponding to the higher probability, and record the assignment result. The greater probability corresponding to the wireless access point 200 represents that the load of the wireless access point 200 is lighter. Therefore, the server 100 may preferentially select the wireless access point 200 to serve the selected wireless device 300.

Taking the wireless device #2 in Table 3 and Table 4 as an example, it is assumed that the wireless device #2 is the selected wireless device 300. The server 100 may select the wireless access point #A corresponding to the greater probability (P (#2-#A)>P (#2-#B)) from the wireless access point #A and the wireless access point #B, and assign the wireless device #2 to the wireless access point #A. Accordingly, Table 3 may be updated to Table 5, wherein the remaining quota of the wireless access point #A is changed from two to one.

TABLE 5

| | #1 | #2 | #3 | | | | #7 | #8 | |
|---|---|---|---|---|---|---|---|---|---|
| | (#B) | (#A) | (#B) | #4 | #5 | #6 | (#A) | (#C) | #9 |
| #A | | −6 | | | −3 | −3 | −5 | | −12 |
| (1) | | | | | | | | | |
| #B | −12 | −6 | −3 | −9 | −6 | | | | −3 |
| (1) | | | | | | | | | |
| #C | | | | −8 | −6 | −9 | | −12 | −6 |
| (2) | | | | | | | | | |

In step S216, the server 100 may compare the signal strengths of the wireless signals measured by the K number of wireless access points 200 scanned to the selected wireless device 300, and determine whether the K number of signal strengths are the same. If the K number of signal strengths are the same, step S218 is performed. If the K number of signal strengths include different signal strengths, step S217 is performed.

In step S217, the server 100 may select the wireless access point 200 corresponding to the greater signal strength from the K number of wireless access points 200 scanned to the selected wireless device 300, assign the wireless device 300 to the wireless access point 200 corresponding to the greater signal strength, and record the assignment result.

Taking the wireless device #6 in Table 3 and Table 4 as an example, it is assumed that the wireless device #6 is the selected wireless device 300, and the two probabilities of the wireless device #6 are the same (P (#6-#A)=P (#6-#C)). The server 100 may compare the signal strengths measured by the wireless access points #A and #C scanned to the wireless device #6. Since the signal strength of the wireless access point #A is greater than the signal strength of the wireless access point #C (signal strength-3 dBm is greater than signal strength-9 dBm), the server 100 may assign the wireless device #6 to the wireless access point #A, and then update Table 3 to Table 6, wherein the remaining quota of the wireless access point #A is changed from two to one.

TABLE 6

| | #1 | | #3 | | | #6 | #7 | #8 | |
|---|---|---|---|---|---|---|---|---|---|
| | (#B) | #2 | (#B) | #4 | #5 | (#A) | (#A) | (#C) | #9 |
| #A | | −6 | | | −3 | −3 | −5 | | −12 |
| (1) | | | | | | | | | |
| #B | −12 | −6 | −3 | −9 | −6 | | | | −3 |
| (1) | | | | | | | | | |
| #C | | | | −8 | −6 | −9 | | −12 | −6 |
| (2) | | | | | | | | | |

In step S218, the server 100 may randomly select the selected wireless access point from among the K number of wireless access points 200 scanned to the selected wireless device 300 (or according to user-defined rules, such as the index of the wireless access point 200). The server 100 may assign the selected wireless device 300 to the selected wireless access point 200, and record the assignment result.

In step S219, the server 100 may determine whether there is an unassigned wireless device 300 included in the K number of subsets. If the wireless device 300 exists, step S212 is performed again. If the wireless device 300 does not exist, step S220 is performed again.

In step S220, the server 100 may determine whether there is an unassigned wireless device 300. If the wireless device 300 exists, step S221 is performed. If the wireless device 300 does not exist, the server 100 outputs the assignment result and ends the process.

In step S221, the server 100 may determine whether the wireless access point list includes a wireless access point 200 with a remaining quota of zero. If the access point list includes a wireless access point 200 with a remaining quota of zero, the server 100 may delete the wireless access point 200 with a remaining quota of zero from the wireless access point list, and performs step S202 again. Before step S202 is performed again, the server 100 may reset K to an initial value of two. If the wireless access point list does not include a wireless access point 200 with a remaining quota of zero, the server 100 adds one to K, and performs step S210 again.

Table 7 is a first example of scanning results obtained by the server 100 via a plurality of wireless access points 200. The following uses Table 7 as an example to describe the execution process of the method shown in FIG. 2. The server 100 may determine that the assigned wireless device #2 is not scanned by any wireless access point 300. Accordingly, the server 100 may output an alert message, wherein the alert message may indicate that the system 10 includes a wireless device 300 not scanned by any wireless access point 200.

TABLE 7

| | #1 | #2 | #3 | #4 | #5 | #6 | #7 | #8 | #9 |
|---|---|---|---|---|---|---|---|---|---|
| #A | | | | | −3 | −3 | −5 | | −12 |
| (3) | | | | | | | | | |
| #B | −12 | | −3 | −9 | −6 | | | | −3 |
| (3) | | | | | | | | | |
| #C | | | | −8 | −6 | −9 | | −12 | −6 |
| (3) | | | | | | | | | |

Table 8 is a second example of scanning results obtained by the server 100 via a plurality of wireless access points 200. The following uses Table 8 as an example to describe the execution process of the method shown in FIG. 2.

TABLE 8

| | #1 | #2 | #3 | #4 | #5 | #6 | #7 | #8 | #9 |
|---|---|---|---|---|---|---|---|---|---|
| #A | | | | | −3 | −3 | −5 | | −12 |
| (3) | | | | | | | | | |
| #B | −12 | −8 | −3 | −9 | −6 | | | | −3 |
| (3) | | | | | | | | | |
| #C | | | | | −6 | −9 | | −12 | −6 |
| (3) | | | | | | | | | |

The server 100 may determine that the wireless devices #1, #2, and #3 are only scanned by a single wireless access point #B. Accordingly, the server 100 may assign the wireless devices #1, #2, and #3 to the wireless access point #B. The remaining quota of the access point #B is changed from three to zero, as shown in Table 9. After the wireless device #4 becomes the selected wireless device 300, the server 100 may determine whether the remaining quota of the wireless access point #B corresponding to the wireless device #4 is zero. Since the remaining quota of the wireless access point #B becomes zero, the server 100 may determine that the remaining quota of the wireless access point #B is insufficient. Accordingly, the server 100 may output an alert message, wherein the alert message may indicate that the wireless device #4 may be not assigned to any wireless access point 200.

TABLE 9

| | #1 | #2 | #3 | | | | | | |
|---|---|---|---|---|---|---|---|---|---|
| | (#B) | (#B) | (#B) | #4 | #5 | #6 | #7 | #8 | #9 |
| #A | | | | | −3 | −3 | −5 | | −12 |
| (3) | | | | | | | | | |
| #B | −12 | −8 | −3 | −9 | −6 | | | | −3 |
| (0) | | | | | | | | | |
| #C | | | | | −6 | −9 | | −12 | −6 |
| (3) | | | | | | | | | |

Table 10 is a third example of scanning results obtained by the server 100 via a plurality of wireless access points 200. The following uses Table 10 as an example to describe the execution process of the method shown in FIG. 2.

TABLE 10

| | #1 | #2 | #3 | #4 | #5 | #6 | #7 | #8 | #9 |
|---|---|---|---|---|---|---|---|---|---|
| #A | | −6 | | −5 | −3 | −3 | −5 | | −12 |
| (3) | | | | | | | | | |
| #B | −10 | −8 | −3 | −9 | −6 | | −5 | −5 | −3 |
| (3) | | | | | | | | | |
| #C | −5 | | −5 | −8 | −6 | −9 | | −12 | −6 |
| (3) | | | | | | | | | |

It may be known from Table 10 that the wireless devices #1, #2, #3, #6, #7, and #8 are scanned by two wireless access points 200 at the same time. The server 100 may calculate the corresponding two probabilities for each of the wireless devices #1, #2, #3, #6, #7, and #8, and calculate the total probability of the two probabilities, as shown in Table 11.

TABLE 11

| | #1 | #2 | #3 | #6 | #7 | #8 |
|---|---|---|---|---|---|---|
| #A | — | P(#2-#A) = 3/6 | — | P(#6-#A) = 3/6 | P(#7-#A) = 3/6 | — |
| (3) | | | | | | |
| #B | P(#1-#B) = 3/8 | P(#2-#B) = 3/8 | P(#3-#B) = 3/8 | — | P(#7-#B) = 3/8 | P(#8-#B) = 3/8 |
| (3) | | | | | | |
| #C | P(#1-#C) = 3/7 | — | P(#3-#C) = 3/7 | P(#6-#C) = 3/7 | — | P(#8-#C) = 3/7 |
| (3) | | | | | | |
| Total | 45/56 | 7/8 | 45/56 | 13/14 | 7/8 | 45/56 |
| probability | | | | | | |

Since the total probability of the wireless devices #1, #3, and #8 is the smallest, the server 100 may first assign a wireless access point to one of the wireless devices #1, #3, and #8. Taking the wireless device #1 as an example, the server 100 may select the wireless access point #C corresponding to the higher probability from the wireless access points #B and #C, and then assign the wireless device #1 to the wireless access point #C. Accordingly, Table 10 may be updated as Table 12.

TABLE 12

| | #1 | | | | | | | | |
|---|---|---|---|---|---|---|---|---|---|
| | (#C) | #2 | #3 | #4 | #5 | #6 | #7 | #8 | #9 |
| #A | | −6 | | −5 | −3 | −3 | −5 | | −12 |
| (3) | | | | | | | | | |
| #B | −10 | −8 | −3 | −9 | −6 | | −5 | −5 | −3 |
| (3) | | | | | | | | | |
| #C | −5 | | −5 | −8 | −6 | −9 | | −12 | −6 |
| (2) | | | | | | | | | |

After the wireless unit #1 is assigned, the server 100 may calculate the corresponding two probabilities for each of the wireless devices #2, #3, #6, #7, and #8 again, and calculate the total probability of the two probabilities, as shown in Table 13.

TABLE 13

| | #2 | #3 | #6 | #7 | #8 |
|---|---|---|---|---|---|
| #A | P(#2-#A) = 3/6 | — | P(#6-#A) = 3/6 | P(#7-#A) = 3/6 | — |
| (3) | | | | | |
| #B | P(#2-#B) = 3/7 | P(#3-#B) = 3/7 | — | P(#7-#B) = 3/7 | P(#8-#B) = 3/7 |
| (3) | | | | | |
| #C | — | P(#3-#C) = 2/6 | P(#6-#C) = 2/6 | — | P(#8-#C) = 2/6 |
| (2) | | | | | |
| Total | 39/42 | 16/21 | 5/6 | 39/42 | 16/21 |
| probability | | | | | |

Since the total probability of the wireless devices #3 and #8 is the smallest, the server 100 may first assign a wireless access point to one of the wireless devices #3 and #8. Taking the wireless device #3 as an example, the server 100 may select the wireless access point #B corresponding to the higher probability from the wireless access points #B and #C, and then assign the wireless device #3 to the wireless access point #B. Accordingly, Table 12 may be updated as Table 14.

TABLE 14

| | #1 | | #3 | | | | | | |
|---|---|---|---|---|---|---|---|---|---|
| | (#C) | #2 | (#B) | #4 | #5 | #6 | #7 | #8 | #9 |
| #A | | −6 | | −5 | −3 | −3 | −5 | | −12 |
| (3) | | | | | | | | | |
| #B | −10 | −8 | −3 | −9 | −6 | | −5 | −5 | −3 |
| (2) | | | | | | | | | |
| #C | −5 | | −5 | −8 | −6 | −9 | | −12 | −6 |
| (2) | | | | | | | | | |

After the wireless unit #3 is assigned the server 100 may calculate the corresponding two probabilities for each of the wireless devices #2, #6, #7, and #8 again, and calculate the total probability of the two probabilities, as shown in Table 15.

TABLE 15

| | #2 | #6 | #7 | #8 |
|---|---|---|---|---|
| #A (3) | P(#2- | P(#6- | P(#7- | — |
| | #A) = 3/6 | #A) = 3/6 | #A) = 3/6 | |
| #B (2) | P(#2- | — | P(#7- | P(#8- |
| | #B) = 2/6 | | #B) = 2/6 | #B) = 2/6 |
| #C (2) | — | P(#6- | — | P(#8- |
| | | #C) = 2/5 | | #C) = 2/5 |
| Total | 5/6 | 27/30 | 5/6 | 22/30 |
| probability | | | | |

Since the total probability of the wireless devices #8 is the smallest, the server 100 may first assign a wireless access point to the wireless device #8. The server 100 may select the wireless access point #C corresponding to the higher probability from the wireless access points #B and #C, and then assign the wireless device #8 to the wireless access point #C. Accordingly, Table 14 may be updated as Table 16.

TABLE 16

| | #1 | | #3 | | | | | #8 | |
|---|---|---|---|---|---|---|---|---|---|
| | (#C) | #2 | (#B) | #4 | #5 | #6 | #7 | (#C) | #9 |
| #A | | −6 | | −5 | −3 | −3 | −5 | | −12 |
| (3) | | | | | | | | | |
| #B | −10 | −8 | −3 | −9 | −6 | | −5 | −5 | −3 |
| (2) | | | | | | | | | |
| #C | −5 | | −5 | −8 | −6 | −9 | | −12 | −6 |
| (1) | | | | | | | | | |

After the wireless unit #8 is assigned, the server 100 may calculate the corresponding two probabilities for each of the wireless devices #2, #6, and #7 again, and calculate the total probability of the two probabilities, as shown in Table 17.

TABLE 17

| | #2 | #6 | #7 |
|---|---|---|---|
| #A (3) | P(#2-#A) = 3/6 | P(#6-#A) = 3/6 | P(#7-#A) = 3/6 |
| #B (2) | P(#2-#B) = 2/5 | — | P(#7-#B) = 2/5 |
| #C (1) | — | P(#6-#C) = 1/4 | — |
| Total | 27/30 | 3/4 | 27/30 |
| probability | | | |

Since the total probability of the wireless devices #16 is the smallest, the server 100 may first assign a wireless access point to the wireless device #6. The server 100 may select the wireless access point #A corresponding to the higher probability from the wireless access points #A and #C, and then assign the wireless device #6 to the wireless access point #A. Accordingly, Table 16 may be updated as Table 18.

TABLE 18

| | #1 | | #3 | | | #6 | | #8 | |
|---|---|---|---|---|---|---|---|---|---|
| | (#C) | #2 | (#B) | #4 | #5 | (#A) | #7 | (#C) | #9 |
| #A | | −6 | | −5 | −3 | −3 | −5 | | −12 |
| (2) | | | | | | | | | |
| #B | −10 | −8 | −3 | −9 | −6 | | −5 | −5 | −3 |
| (2) | | | | | | | | | |
| #C | −5 | | −5 | −8 | −6 | −9 | | −12 | −6 |
| (1) | | | | | | | | | |

After the wireless unit #6 is assigned, the server 100 may calculate the corresponding two probabilities for each of the wireless devices #2 and #7 again, and calculate the total probability of the two probabilities, as shown in Table 19.

TABLE 19

| | #2 | #7 |
|---|---|---|
| #A (2) | P(#2-#A) = 2/5 | P(#7-#A) = 2/5 |
| #B (2) | P(#2-#B) = 2/5 | P(#7-#B) = 2/5 |
| #C (1) | — | — |
| Total probability | 4/5 | 4/5 |

Since the total probability of the wireless devices #2 and #7 is the smallest, the server 100 may first assign a wireless access point to one of the wireless devices #2 and #7. Taking the wireless device #2 as an example, the server 100 may select the wireless access point #A corresponding to the greater signal strength from the wireless access points #A and #B, and then assign the wireless device #2 to the wireless access point #B. Accordingly, Table 18 may be updated as Table 20.

TABLE 20

| | #1 | #2 | #3 | | | #6 | | #8 | |
|---|---|---|---|---|---|---|---|---|---|
| | (#C) | (#A) | (#B) | #4 | #5 | (#A) | #7 | (#C) | #9 |
| #A | | −6 | | −5 | −3 | −3 | −5 | | −12 |
| (1) | | | | | | | | | |
| #B | −10 | −8 | −3 | −9 | −6 | | −5 | −5 | −3 |
| (2) | | | | | | | | | |
| #C | −5 | | −5 | −8 | −6 | −9 | | −12 | −6 |
| (1) | | | | | | | | | |

After the wireless device #2 is assigned, the server 100 may recalculate the corresponding two probabilities for the wireless device #7, as shown in Table 21.

TABLE 21

| | #7 |
|---|---|
| #A (1) | P(#7-#A) = 1/4 |
| #B (2) | P(#7-#B) = 2/4 |
| #C (1) | — |

The server 100 may select the wireless access point #FB corresponding to the higher probability from the wireless access points #A and #FB, and then assign the wireless device #7 to the wireless access point #B. Accordingly, Table 20 may be updated as Table 22.

TABLE 22

| | #1 | #2 | #3 | | | #6 | #7 | #8 | |
|---|---|---|---|---|---|---|---|---|---|
| | (#C) | (#A) | (#B) | #4 | #5 | (#A) | (#B) | (#C) | #9 |
| #A | | −6 | | −5 | −3 | −3 | −5 | | −12 |
| (1) | | | | | | | | | |
| #B | −10 | −8 | −3 | −9 | −6 | | −5 | −5 | −3 |
| (1) | | | | | | | | | |
| #C | −5 | | −5 | −8 | −6 | −9 | | −12 | −6 |
| (1) | | | | | | | | | |

After the wireless devices #1, #2, #3, #6, #7, and #8 scanned by the two wireless access points 200 are assigned, the server 100 may perform wireless access point assignment for the wireless devices #4, #5, and #9 scanned by the three wireless access points 200. The server 100 may calculate the corresponding three probabilities for each of the wireless devices #4, #5, and #9, and calculate the total probability of the three probabilities, as shown in Table 23.

TABLE 23

| | #4 | #5 | #9 |
|---|---|---|---|
| #A (1) | P(#4-#A) = 1/3 | P(#5-#A) = 1/3 | P(#9-#A) = 1/3 |
| #B (1) | P(#4-#B) = 1/3 | P(#5-#B) = 1/3 | P(#9-#B) = 1/3 |
| #C (1) | P(#4-#C) = 1/3 | P(#5-#C) = 1/3 | P(#9-#C) = 1/3 |
| Total probability | 1 | 1 | 1 |

Since the total probability of the wireless devices #4, #5, and #9 is the smallest, the server 100 may first assign a wireless access point to one of the wireless devices #4, #5, and #9. Taking the wireless device #4 as an example, the server 100 may select the wireless access point #A corresponding to the greater signal strength from the wireless access points #A, #B, and #C, and then assign the wireless device #4 to the wireless access point #A. Accordingly, Table 22 may be updated as Table 24.

TABLE 24

| | #1 | #2 | #3 | #4 | | #6 | #7 | #8 | |
|---|---|---|---|---|---|---|---|---|---|
| | (#C) | (#A) | (#B) | (#A) | #5 | (#A) | (#B) | (#C) | #9 |
| #A | | −6 | | −5 | −3 | −3 | −5 | | −12 |
| (0) | | | | | | | | | |
| #B | −10 | −8 | −3 | −9 | −6 | | −5 | −5 | −3 |
| (1) | | | | | | | | | |
| #C | −5 | | −5 | −8 | −6 | −9 | | −12 | −6 |
| (1) | | | | | | | | | |

After the wireless device #4 is assigned, the server 100 may delete the wireless access point #A with a remaining quota of zero from the wireless access point list. After the wireless access point #A is deleted from the wireless access point list, the server 100 may determine that the unassigned wireless devices #5 and #9 are scanned by the two wireless access points 200. Accordingly, the server 100 may calculate the corresponding two probabilities for each of the wireless devices #5 and #9, and calculate the total probability of the two probabilities, as shown in Table 25.

TABLE 25

| | #5 | #9 |
|---|---|---|
| #B (1) | P(#5-#B) = 1/2 | P(#9-#B) = 1/2 |
| #C (1) | P(#5-#C) = 1/2 | P(#9-#B) = 1/2 |
| Total probability | 1 | 1 |

Since the total probability of the wireless devices #5 and #9 is the smallest, the server 100 may first assign a wireless access point to one of the wireless devices #5 and #9. Taking the wireless device #5 as an example, since the wireless access points #B and #C correspond to the same probability and signal strength, the server 100 may randomly select the wireless access point #B from the wireless access points #B and #C as the selected wireless access point 200, and then assign the wireless device #5 to the wireless access point #B. Accordingly, Table 24 may be updated as Table 26.

TABLE 26

| | #1 | #2 | #3 | #4 | #5 | #6 | #7 | #8 | |
|---|---|---|---|---|---|---|---|---|---|
| | (#C) | (#A) | (#B) | (#A) | (#B) | (#A) | (#B) | (#C) | #9 |
| #A | | −6 | | −5 | −3 | −3 | −5 | | −12 |
| (0) | | | | | | | | | |
| #B | −10 | −8 | −3 | −9 | −6 | | −5 | −5 | −3 |
| (0) | | | | | | | | | |
| #C | −5 | | −5 | −8 | −6 | −9 | | −12 | −6 |
| (1) | | | | | | | | | |

After the wireless device #5 is assigned, the server 100 may delete the wireless access point #B with a remaining quota of zero from the wireless access point list. After the wireless access point #B is deleted from the wireless access point list, the server 100 may determine that the unassigned wireless device #9 is only scanned by a single wireless access point #C. The server 100 may assign the wireless devices #9 to the wireless access point #C. Accordingly, Table 26 may be updated as Table 27. The server 100 may output the assignment results shown in Table 27 for the user's reference.

TABLE 27

| | #1 | #2 | #3 | #4 | #5 | #6 | #7 | #8 | #9 |
|---|---|---|---|---|---|---|---|---|---|
| | (#C) | (#A) | (#B) | (#A) | (#B) | (#A) | (#B) | (#C) | (#C) |
| #A | | −6 | | −5 | −3 | −3 | −5 | | −12 |
| (0) | | | | | | | | | |
| #B | −10 | −8 | −3 | −9 | −6 | | −5 | −5 | −3 |
| (0) | | | | | | | | | |
| #C | −5 | | −5 | −8 | −6 | −9 | | −12 | −6 |
| (0) | | | | | | | | | |

Table 28 is a fourth example of scanning results obtained by the server 100 via a plurality of wireless access points 200. The following uses Table 28 as an example to describe the execution process of the method shown in FIG. 2.

TABLE 28

| | #1 | #2 | #3 | #4 | #5 | #6 | #7 | #8 | #9 |
|---|---|---|---|---|---|---|---|---|---|
| #A | | −6 | −12 | | | −8 | −3 | | |
| (3) | | | | | | | | | |
| #B | −5 | −4 | −6 | | −3 | | −5 | −7 | −8 |
| (3) | | | | | | | | | |
| #C | | | −9 | −5 | −9 | −3 | | −7 | −5 |
| (3) | | | | | | | | | |

It may be seen from Table 28 that the wireless device #1 is only scanned by a single wireless access point #B, and the wireless device #4 is only scanned by a single wireless access point #C. Accordingly, the server 100 may assign the wireless devices #1 and #4 to the wireless access points #B and #C respectively. The remaining quotas of the access points #B and #C are changed from three to two, as shown in Table 29.

TABLE 29

| | #1 | | | #4 | | | | | |
|---|---|---|---|---|---|---|---|---|---|
| | (#B) | #2 | #3 | (#C) | #5 | #6 | #7 | #8 | #9 |
| #A | | −6 | −12 | | | −8 | −3 | | |
| (3) | | | | | | | | | |
| #B | −5 | −4 | −6 | | −3 | | −5 | −7 | −8 |
| (2) | | | | | | | | | |
| #C | | | −9 | −5 | −9 | −3 | | −7 | −5 |
| (2) | | | | | | | | | |

After confirming that the remaining quotas of the wireless access points #A, #B, and #C are all not zero, the server 100 may determine that the wireless devices #2, #5, #6, #7, #8, and #9 are scanned by two wireless access points 200 at the same time. The server 100 may calculate the corresponding two probabilities for each of the wireless devices #2, #5, #6, #7, #8, and #9, and calculate the total probability of the two probabilities, as shown in Table 30.

TABLE 30

| | #2 | #5 | #6 | #7 | #8 | #9 |
|---|---|---|---|---|---|---|
| #A | P(#2-#A) = 3/4 | | P(#6-#A) = 3/4 | P(#7-#A) = 3/4 | | |
| (3) | | | | | | |
| #B | P(#2-#B) = 2/6 | P(#5-#B) = 2/6 | | P(#7-#B) = 2/6 | P(#8-#B) = 2/6 | P(#9-#B) = 2/6 |
| (3) | | | | | | |
| #C | | P(#5-#C) = 2/5 | P(#6-#C) = 2/5 | | P(#8-#C) = 2/5 | P(#9-#C) = 2/5 |
| (3) | | | | | | |
| Total | 13/12 | 11/15 | 23/20 | 13/12 | 11/15 | 11/15 |
| probability | | | | | | |

Since the total probability of the wireless devices #5, #8, and #9 is the smallest, the server 100 may first assign a wireless access point to one of the wireless devices #5, #8, and #9. Taking the wireless device #5 as an example, the server 100 may select the wireless access point #C corresponding to the higher probability from the wireless access points #B and #C, and then assign the wireless device #5 to the wireless access point #C. Accordingly, Table 29 may be updated as Table 31.

TABLE 31

| | #1 | | | #4 | #5 | | | | |
|---|---|---|---|---|---|---|---|---|---|
| | (#B) | #2 | #3 | (#C) | (#C) | #6 | #7 | #8 | #9 |
| #A | | −6 | −12 | | | −8 | −3 | | |
| (3) | | | | | | | | | |
| #B | −5 | −4 | −6 | | −3 | | −5 | −7 | −8 |
| (2) | | | | | | | | | |
| #C | | | −9 | −5 | −9 | −3 | | −7 | −5 |
| (1) | | | | | | | | | |

After the wireless unit #5 is assigned, the server 100 may calculate the corresponding two probabilities for each of the wireless devices #2, #6, #7, #8, and #9 again, and calculate the total probability of the two probabilities, as shown in Table 32.

TABLE 32

| | #2 | #6 | #7 | #8 | #9 |
|---|---|---|---|---|---|
| #A (3) | P(#2- | P(#6- | P(#7- | | |
| | #A) = 3/4 | #A) = 3/4 | #A) = 3/4 | | |
| #B (3) | P(#2- | | P(#7- | P(#8- | P(#9- |
| | #B) = 2/6 | | #B) = 2/6 | #B) = 2/6 | #B) = 2/6 |
| #C (3) | | P(#6- | | P(#8- | P(#9- |
| | | #C) = 1/5 | | #C) = 1/5 | #C) = 1/5 |
| Total | 13/12 | 19/20 | 13/12 | 8/15 | 8/15 |
| probability | | | | | |

Since the total probability of the wireless devices #8 and #9 is the smallest, the server 100 may first assign a wireless access point to one of the wireless devices #8 and #9. Taking the wireless device #8 as an example, the server 100 may select the wireless access point #B corresponding to the higher probability from the wireless access points #B and #C, and then assign the wireless device #8 to the wireless access point #B. Accordingly, Table 31 may be updated as Table 33.

TABLE 33

| | #1 | | | #4 | #5 | | | #8 | |
|---|---|---|---|---|---|---|---|---|---|
| | (#B) | #2 | #3 | (#C) | (#C) | #6 | #7 | (#B) | #9 |
| #A | | −6 | −12 | | | −8 | −3 | | |
| (3) | | | | | | | | | |
| #B | −5 | −4 | −6 | | −3 | | −5 | −7 | −8 |
| (1) | | | | | | | | | |
| #C | | | −9 | −5 | −9 | −3 | | −7 | −5 |
| (1) | | | | | | | | | |

After the wireless unit #8 is assigned, the server 100 may calculate the corresponding two probabilities for each of the wireless devices #2, #6, #7, and #9 again, and calculate the total probability of the two probabilities, as shown in Table 34.

TABLE 34

| | #2 | #6 | #7 | #9 |
|---|---|---|---|---|
| #A (3) | P(#2- | P(#6- | P(#7- | |
| | #A) = 3/4 | #A) = 3/4 | #A) = 3/4 | |
| #B (3) | P(#2- | | P(#7- | P(#9- |
| | #B) = 1/6 | | #B) = 1/6 | #B) = 1/6 |
| #C (3) | | P(#6- | | P(#9- |
| | | #C) = 1/5 | | #C) = 1/5 |
| Total | 22/24 | 19/20 | 22/24 | 11/30 |
| probability | | | | |

Since the total probability of the wireless devices #9 is the smallest, the server 100 may first assign a wireless access point to the wireless device #9. The server 100 may select the wireless access point #C corresponding to the higher probability from the wireless access points #B and #C, and then assign the wireless device #9 to the wireless access point #C. Accordingly, Table 33 may be updated as Table 35.

TABLE 35

| | #1 | | | #4 | #5 | | | #8 | #9 |
|---|---|---|---|---|---|---|---|---|---|
| | (#B) | #2 | #3 | (#C) | (#C) | #6 | #7 | (#B) | (#C) |
| #A | | −6 | −12 | | | −8 | −3 | | |
| (3) | | | | | | | | | |
| #B | −5 | −4 | −6 | | −3 | | −5 | −7 | −8 |
| (1) | | | | | | | | | |
| #C | | | −9 | −5 | −9 | −3 | | −7 | −5 |
| (0) | | | | | | | | | |

After the wireless device #9 is assigned, the server 100 may delete the wireless access point #C with a remaining quota of zero from the wireless access point list. After the wireless access point #C is deleted from the wireless access point list, the server 100 may determine that the unassigned wireless device #6 is only scanned by a single wireless access point #A. The server 100 may assign the wireless devices #6 to the wireless access point #A. Accordingly, Table 35 may be updated as Table 36.

TABLE 36

| | #1 | | | #4 | #5 | #6 | | #8 | #9 |
|---|---|---|---|---|---|---|---|---|---|
| | (#B) | #2 | #3 | (#C) | (#C) | (#A) | #7 | (#B) | (#C) |
| #A | | −6 | −12 | | | −8 | −3 | | |
| (2) | | | | | | | | | |
| #B | −5 | −4 | −6 | | −3 | | −5 | −7 | −8 |
| (1) | | | | | | | | | |
| #C | | | −9 | −5 | −9 | −3 | | −7 | −5 |
| (0) | | | | | | | | | |

After the wireless device #6 is assigned, the server 100 may determine that the wireless devices #2, #3, and #7 are scanned by two wireless access points 200 at the same time. The server 100 may calculate the corresponding two probabilities for each of the wireless devices #2, #3, and #7, and calculate the total probability of the two probabilities, as shown in Table 37.

TABLE 37

| | #2 | #3 | #7 |
|---|---|---|---|
| #A (3) | P(#2-#A) = 2/3 | P(#3-#A) = 2/3 | P(#7-#A) = 2/3 |
| #B (3) | P(#2-#B) = 1/3 | | P(#7-#B) = 1/3 |
| #C (3) | | P(#3-#C) = 1/3 | |
| Total probability | 1 | 1 | 1 |

Since the total probability of the wireless devices #2, #3, and #7 is the smallest, the server 100 may first assign a wireless access point to one of the wireless devices #2, #3, and #7. Taking the wireless device #2 as an example, the server 100 may select the wireless access point #A corresponding to the higher probability from the wireless access points #A and #B, and then assign the wireless device #2 to the wireless access point #A. Accordingly, Table 36 may be updated as Table 38.

TABLE 38

| | #1 | #2 | | #4 | #5 | #6 | | #8 | #9 |
|---|---|---|---|---|---|---|---|---|---|
| | (#B) | (#A) | #3 | (#C) | (#C) | (#A) | #7 | (#B) | (#C) |
| #A | | −6 | −12 | | | −8 | −3 | | |
| (1) | | | | | | | | | |
| #B | −5 | −4 | −6 | | −3 | | −5 | −7 | −8 |
| (1) | | | | | | | | | |
| #C | | | −9 | −5 | −9 | −3 | | −7 | −5 |
| (0) | | | | | | | | | |

After the wireless unit #2 is assigned, the server 100 may calculate the corresponding two probabilities for each of the wireless devices #3 and #7 again, and calculate the total probability of the two probabilities, as shown in Table 39.

TABLE 39

| | #3 | #7 |
|---|---|---|
| #A (1) | P(#3-#A) = 1/2 | P(#7-#A) = 1/2 |
| #B (1) | P(#3-#C) = 1/2 | P(#7-#B) = 1/2 |
| #C (0) | | |
| Total probability | 1 | 1 |

Since the total probability of the wireless devices #3 and #7 is the smallest, the server 100 may first assign a wireless access point to one of the wireless devices #3 and #7. Taking the wireless device #3 as an example, since the wireless access points #A and #B correspond to the same probability, the server 100 may select the wireless access point #A corresponding to the greater signal strength from the wireless access points #A and #B, and then assign the wireless device #3 to the wireless access point #B. Accordingly, Table 38 may be updated as Table 40.

TABLE 40

| | #1 | #2 | #3 | #4 | #5 | #6 | | #8 | #9 |
|---|---|---|---|---|---|---|---|---|---|
| | (#B) | (#A) | (#A) | (#C) | (#C) | (#A) | #7 | (#B) | (#C) |
| #A | | −6 | −12 | | | −8 | −3 | | |
| (1) | | | | | | | | | |
| #B | −5 | −4 | −6 | | −3 | | −5 | −7 | −8 |
| (0) | | | | | | | | | |
| #C | | | −9 | −5 | −9 | −3 | | −7 | −5 |
| (0) | | | | | | | | | |

After the wireless device #3 is assigned, since the wireless device #7 may only match with the wireless access point #A, the server 100 may assign the wireless device #7 to the wireless access point #A. Accordingly, Table 40 may be updated as Table 41. The server 100 may output the assignment results shown in Table 41 for the user's reference.

TABLE 41

| | #1 | #2 | #3 | #4 | #5 | #6 | #7 | #8 | #9 |
|---|---|---|---|---|---|---|---|---|---|
| | (#B) | (#A) | (#A) | (#C) | (#C) | (#A) | (#A) | (#B) | (#C) |
| #A | | −6 | −12 | | | −8 | −3 | | |
| (0) | | | | | | | | | |
| #B | −5 | −4 | −6 | | −3 | | −5 | −7 | −8 |
| (0) | | | | | | | | | |
| #C | | | −9 | −5 | −9 | −3 | | −7 | −5 |
| (0) | | | | | | | | | |

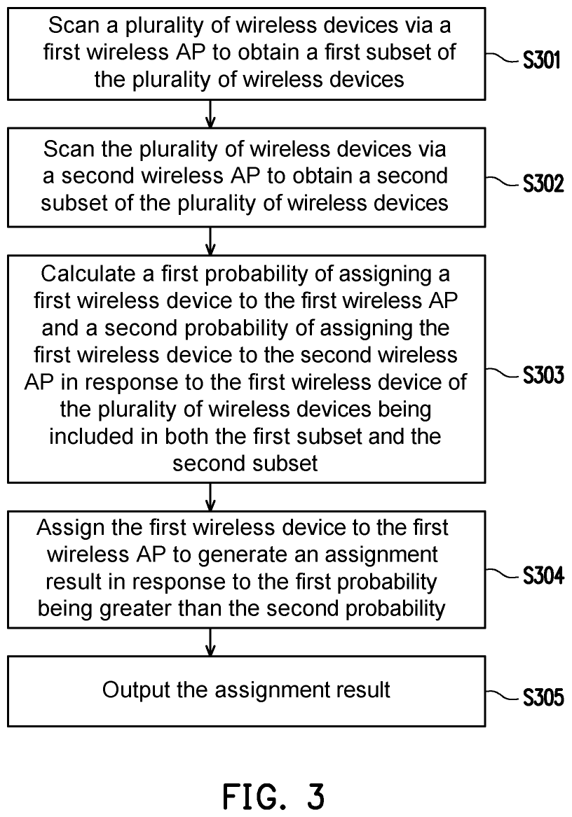

FIG. 3 shows a flowchart of another method for wireless access point assignment according to an embodiment of the invention, wherein the method may be implemented by the system 10 shown in FIG. 1. In step S301, a plurality of wireless devices are scanned by a first wireless access point to obtain a first subset of the plurality of wireless devices. In step S302, the plurality of wireless devices are scanned by a second wireless access point to obtain a second subset of the plurality of wireless devices. In step S303, a first probability of assigning a first wireless device to the first wireless access point and a second probability of assigning the first wireless device to the second wireless access point are calculated in response to the first wireless device of the plurality of wireless devices being included in both the first subset and the second subset. In step S304, the first wireless device is assigned to the first wireless access point to generate an assignment result in response to the first probability being greater than the second probability. In step S305, the assignment result is output.

Based on the above, the system of the invention can monitor the wireless signals between each wireless device and each wireless access point, and then assign the best wireless access point to the wireless device according to the signal strength. The system may prioritize wireless access points for wireless devices with worse connectivity. In addition, the system may preferentially assign wireless devices to wireless access points with more remaining quotas. Accordingly, the invention may optimize the communication quality of each of the wireless devices, and may reduce the probability that the wireless devices may not be served by any wireless access point.

What is claimed is:

1. A system for wireless access point assignment, comprising:
a plurality of wireless devices;
a first wireless access point;
a second wireless access point; and
a server communicatively coupled to the first wireless access point and the second wireless access point and configured to perform:
scanning the plurality of wireless devices via the first wireless access point to obtain a first subset of the plurality of wireless devices;
scanning the plurality of wireless devices via the second wireless access point to obtain a second subset of the plurality of wireless devices;
calculating a first probability of assigning a first wireless device to the first wireless access point and a second probability of assigning the first wireless device to the second wireless access point in response to the first wireless device of the plurality of wireless devices being comprised in both the first subset and the second subset;
assigning the first wireless device to the first wireless access point to generate an assignment result in response to the first probability being greater than the second probability; and
outputting the assignment result.

2. The system of claim 1, wherein the server is further configured to perform:
measuring a first signal strength of the first wireless device via the first wireless access point;
measuring a second signal strength of the first wireless device via the second wireless access point;
comparing the first signal strength and the second signal strength in response to the first probability being equal to the second probability; and
assigning the first wireless device to the first wireless access point to generate the assignment result in response to the first signal strength being greater than the second signal strength.

3. The system of claim 2, wherein the first signal strength is associated with a received signal strength indicator.

4. The system of claim 1, wherein the server is further configured to perform:
obtaining a number of wireless devices in the first subset; and
calculating the first probability by dividing a remaining quota of the first wireless access point by the number of wireless devices.

5. The system of claim 4, wherein the server is further configured to perform:
decreasing the remaining quota of the first wireless access point in response to assigning the first wireless device to the first wireless access point.

6. The system of claim 5, wherein the server is further configured to perform:
determining whether the remaining quota of the first wireless access point is zero;
determining whether an unassigned second wireless device of the plurality of wireless devices is comprised in the second subset in response to determining that the remaining quota is zero; and
outputting an alert message in response to the second wireless device not being comprised in the second subset.

7. The system of claim 1, wherein the server is further configured to perform:
adding the first probability and the second probability to generate a first total probability corresponding to the first wireless device;
comparing the first total probability corresponding to the first wireless device and a second total probability corresponding to a second wireless device of the plurality of wireless devices; and
assigning the first wireless device to the first wireless access point prior to assigning the second wireless device to the first wireless access point or the second wireless access point in response to the first total probability being less than the second total probability.

8. The system of claim 1, wherein the server is further configured to perform:
assigning the first wireless device to the first wireless access point to generate the assignment result in response to the first wireless device being in the first subset but not in the second subset.

9. The system of claim 8, wherein the server is further configured to perform:
determining whether a remaining quota of the first wireless access point is zero in response to the first wireless device being in the first subset but not in the second subset; and
assigning the first wireless device to the first wireless access point in response to determining that the remaining quota is not zero.

10. The system of claim 9, wherein the server is further configured to perform:
outputting an alert message in response to determining that the remaining quota is zero.

11. A method for wireless access point assignment, comprising:
scanning a plurality of wireless devices via a first wireless access point to obtain a first subset of the plurality of wireless devices;
scanning the plurality of wireless devices via a second wireless access point to obtain a second subset of the plurality of wireless devices;
calculating a first probability of assigning a first wireless device to the first wireless access point and a second probability of assigning the first wireless device to the second wireless access point in response to the first wireless device of the plurality of wireless devices being comprised in both the first subset and the second subset;
assigning the first wireless device to the first wireless access point to generate an assignment result in response to the first probability being greater than the second probability; and
outputting the assignment result.
